(19) United States
(12) Patent Application Publication
(10) Pub. No.: US 2007/0237918 A1
(43) Pub. Date: Oct. 11, 2007

(54) WRAPPING MATERIAL COMPRISING A MULTILAYER FILM AS TEAR STRIP

(75) Inventors: James M. Jonza, Woodbury, MN (US); Robert Heinz, Erkelenz (DE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/278,892

(22) Filed: Apr. 6, 2006

(51) Int. Cl. G09F 3/00

(52) U.S. Cl. 428/43

(57) ABSTRACT

In accordance with one aspect, there is provided a wrapping material for wrapping an article, said wrapping material comprising a tear strip associated therewith, wherein said tear strip comprises a multilayer film comprising alternating layers of at least a first and second polymer, said multilayer film having a first optical appearance at a first observation angle and a second optical appearance at a second observation angle different from said first observation angle, said second optical appearance being different from the first optical appearance.

### BACKGROUND

This application generally relates to systems for authenticating articles. The present application relates more particularly to the use of a multilayer film as a tear strip as a means of authentication. The application further relates to a wrapping material having associated therewith a tear strip comprising a multilayer film.

Product diversion and counterfeiting of goods is a major problem. Counterfeiting entails the manufacture of a product that is intended to deceive another as to the true source of the product. Product diversion occurs when a person acquires genuine, non-counterfeit goods that are targeted for one market and sells them in a different market. A diverter typically benefits by selling a product in a limited supply market designed by the product's manufacturer. There may be high pecuniary advantages to counterfeiting and diverting genuine goods. Such monetary gains motivate charlatans to invest large sums of money and resources to defeat anti-counterfeiting and diversion methods.

### SUMMARY

In accordance with one aspect of the present application there is provided a wrapping material for wrapping an article, said wrapping material comprising a tear strip associated therewith, wherein said tear strip comprises a multilayer film comprising alternating layers of at least a first and second polymer, said multilayer film having a first optical appearance at a first observation angle and a second optical appearance at a second observation angle different from said first observation angle, said second optical appearance being different from the first optical appearance.

In a particular embodiment the tear strip comprises a multilayer film comprising alternating layers of at least a first and second polymer, the multilayer film appearing substantially clear at a first observation angle and colored at at least a second observation angle different from said first observation angle, the multilayer film having a series of layer pairs having an optical thickness of 360 nm to 450 nm.

According to a further aspect, there is provided a packaged article comprising a wrapping material as defined above and a method of authenticating an article comprising wrapping an article with the wrapping material.

### BRIEF DESCRIPTION OF THE DRAWINGS

The invention will be described with reference to the drawings, in which like numbers designate like structure throughout the various Figures, and in which:

FIG. 1 is a schematic illustration of the effect of the multilayer film of the present invention when viewed by an observer at two points relative to the film;

FIG. 2 is a perspective view of a multilayer film according to the present invention;

FIGS. 3, 4, 6, 7, 10, 11, and 12 are transmission spectra associated with various modeled film samples;

FIGS. 5, 8, and 9 are graphs of CIE L*a*b color coordinates at various observation angles;

FIGS. 13, 14, and 15 are graphical representations of the relationship between band edge and observation angle;

FIG. 16 is a transmission spectrum showing a color shift with change in angle;

FIG. 17 is a schematic diagram of a manufacturing process for making the multilayer film of the present invention;

FIGS. 18A, 18B, and 18C show the effects of embossing on the multilayer film of the present invention; and

FIGS. 19, 20, 21, 22, 23, and 24 are transmission spectra associated with the Examples.

### DETAILED DESCRIPTION

Numerous methods have been proposed in the art to prevent counterfeiting and diversion of products. Typically such methods employ a step of marking the product with a substance not readily observable in visible light. In one type of anti-counterfeit and anti-diversion measure, an ultraviolet (UV) material is used to mark the product with identifying indicia. Most UV materials are typically not visible when illuminated with light in the visible spectrum (380-770 nm), but are visible when illuminated with light in the UV spectrum (200-380 nm). U.S. Pat. No. 5,569,317 discloses several UV materials that can be used to mark products that become visible when illuminated with UV light having a wavelength of 254 nm.

In another type of anti-counterfeit and anti-diversion measure, an infrared (IR) material is used to mark the product. As with the UV ink, one benefit of using the IR materials is that it is typically not visible when illuminated with light in the visible spectrum. IR materials are visible when illuminated with light in the IR spectrum (800-1600 nm). An additional benefit of using an IR material is that it is more difficult to reproduce or procure the matching IR material by studying a product sample containing the IR security mark. Examples of IR security mark usage are given in U.S. Pat. Nos. 5,611,958 and 5,766,324.

Security may be improved by making authentication marks more difficult to detect and interpret, by incorporating greater complexity into the markings, and by making replication of the mark by a counterfeiter more difficult. Combining multiple kinds of marking indicia can further increase the complexity of detection, interpretation and replication.

For example, the use of security marks containing IR and UV materials has seen increased use. However, as this use has increased, counterfeiters have become correspondingly knowledgeable about their application on products. It is common practice for counterfeiters to examine products for UV and IR marks and to reproduce or procure the same materials, and apply the materials on the counterfeit products in the same position. In U.S. Pat. Nos. 5,360,628 and 5,599,578, a security mark comprising a visible component and an invisible component made up of a combination of a UV dye and a biologic marker, or a combination of an IR dye and a biologic marker is proposed.

The use of fluorescent and phosphorescent materials have also been proposed for marking materials. U.S. Pat. No. 5,698,397 discloses a security mark containing two different types of up-converting phosphors. U.S. Pat. No. 4,146,792 to Stenzel et al. discloses authentication methods that may include use of fluorescing rare-earth elements in marking the goods. Other authentication methods use substances which fluoresce in the infrared portion of the electromagnetic spectrum when illuminated in the visible spectrum range (See, e.g., U.S. Pat. No. 6,373,965).

Non-chemical methods for authenticating items and preventing diversion of items are also known. For example, U.S. Pat. No. 6,162,550 discloses a method for detecting the presence of articles comprising applying a tagging material in the form of a pressure sensitive tape having a first surface coated with pressure sensitive adhesive composition and a second surface opposite the first surface coated with a release agent, the tape including a continuous substrate of synthetic plastics material and a continuous electromagnetic sensor material capable of being detected by detection equipment. The tagging material can be detected by an interrogation field directed to determining magnetic changes.

Authentication marks comprising tagging material are typically applied to the article of commerce itself. However, authentication marks on the article of commerce are not useful when the article is covered by packaging material and a quick determination of counterfeiting or diversion is desired to be made. It is known, therefore, in the art to also provide tags on the packaging of a product (See, e.g., U.S. Pat. No. 6,162,550).

U.S. Pat. No. 6,045,894 discloses a security film comprising a multilayer film comprising alternating layers of at least a first and second polymer, said multilayer film appearing substantially clear at a first observation angle and colored at at least a second observation angle different from said first observation angle, said multilayer film having a series of layer pairs having an optical thickness of 360 nm to 450 nm. In one embodiment, the security film is used as a label or tape adhesively secured to a package of a consumer good so as to authenticate the latter. Although consumer goods so authenticated may be harder to counterfeit than other authenticated materials in the art, the method of authentication disclosed in U.S. Pat. No. 6,045,894 has the disadvantage that the authentication likely interferes with the packaging design and further in that the authentication may be viewable on only one side of the packaged good. Furthermore, such a method of authentication requires additional steps in the packaging process and therefore adds further costs to the packaged good.

Security and anti-counterfeit coding on relatively expensive items, in particular luxury perfume, cosmetics, tobacco products, and pharmaceutical products, is known. Such coding is useful for the traceability of products and identification of the same.

Such coding is typically not unique to the particular item within the general product class. This is probably largely due to the slow speed at which a production line would have to operate to mark in a unique fashion each item, in particular given the current technologies for marking. As such coding is typically not unique to the item, and as experience has shown that generic invisible marks are often detected by counterfeiters and diverters and are easily duplicated on other items within the general product class, there is a great need for an improved method of identifying goods that are either counterfeit or diverted.

US 2005/0153128 proposes the incorporation of light sensitive materials in shipping materials such as for example in a tear strip. According to an embodiment disclosed, using for example a laser, data, e.g. a unique security can then be written on the tear strip. Notwithstanding the high speed of laser recording that can be achieved today, laser writing may still present a slow down of the packaging process of the item to be authenticated and may furthermore complicate and add costs to the packaging of items.

The authentication method according to the invention may provide one or more of several advantages and/or benefit. For example, security features, i.e. the different optical appearance at different angles provided by the multilayer film will generally be hard to simulate or copy due to the limited availability of the multilayer film. Additionally, the multilayer film itself can be used as a tear strip and hence no additional manufacturing steps are required in the packaging process to provide for the anti-counterfeit feature. Thus, a high level of security combined with ease of manufacturing can be achieved. Furthermore, the security feature will generally be viewable from all sides of the packaged item and any interference with the design elements of the packaging is minimized.

The multilayer film of the tear strip has a different optical appearance at at least two different observation angles. In accordance with one embodiment, such a different optical appearance comprises a color shift, i.e. the film has a first color at a first angle and a second color different from the first at a second angle. Multilayer films suitable for providing a color shift are described in U.S. Pat. No. 6,531,230, which is incorporated herein by reference. In an alternative and preferred embodiment, the multi-layer film appears substantially clear at a first observation angle and colored at at least a second observation angle different from the first observation angle and the multilayer film has a series of layer pairs having an optical thickness of 360 nm to 450 nm. This latter embodiment will now be described in more detail hereinafter.

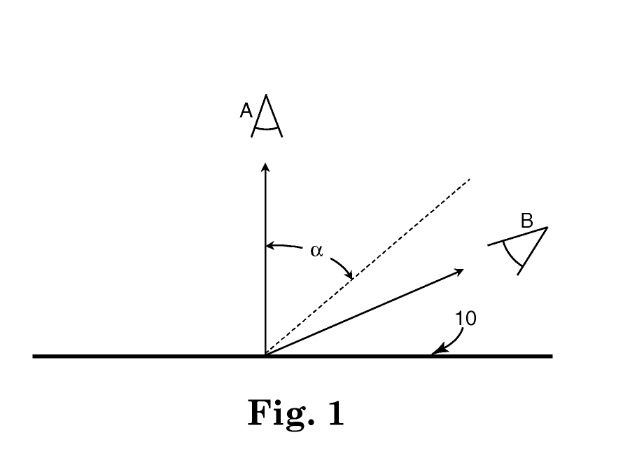

In simplest terms, the multilayer film of the tear strip of a preferred embodiment appears to be clear when viewed by an observer at a zero degree observation angle, and to exhibit a visible color when viewed at an observation angle that is greater than a predetermined shift angle. As used herein, the term “clear” means substantially transparent and substantially colorless, and the term “shift angle” means the angle (measured relative to an optical axis extending perpendicular to the film) at which the film first appears colored. The shift angle is shown at α in FIG. 1. For simplicity, the present application will be described largely in terms of a color shift from clear to cyan. This effect is produced by creating a multilayer film that includes multiple polymeric layers selected to enable the film to reflect light in the near infrared (IR) portion of the visible spectrum at zero degree observation angles, and to reflect red light at angles greater than the shift angle. Depending on the amount and range of red light that is reflected, the film of the present invention appears under certain conditions to exhibit a visible color, commonly cyan. This effect is illustrated in FIG. 1, wherein an observer at A viewing the inventive film at approximately a zero degree observation angle sees through the film 10, whereas an observer at B viewing the film at an observation angle greater than the shift angle α sees a cyan-colored film. The observer at A thus can read information on an item underlying the film, and at B can determine that the film is authentic, and thus that the item underlying the film is also authentic. This effect can be made to occur for light of one or both polarization states.

The construction, materials, and optical properties of conventional multilayer polymeric films are generally known, and were first described in Alfrey et al., Polymer Engineering and Science, Vol. 9, No. 6, pp 400-404, November 1969; Radford et al., Polymer Engineering and Science, Vol. 13, No. 3, pp 216-221, May 1973; and U.S. Pat. No. 3,610,729 (Rogers). More recently patents and publications including PCT International Publication Number WO 95/17303 (Ouderkirk et al.), PCT International Publication Number WO 96/19347 (Jonza et al.), U.S. Pat. No. 5,095,210 (Wheatley et al.), and U.S. Pat. No. 5,149,578 (Wheatley et al.), discuss useful optical effects which can be achieved with large numbers of alternating thin layers of different polymeric materials that exhibit differing optical properties, in particular different refractive indices in different directions. The contents of all of these references are incorporated by reference herein.

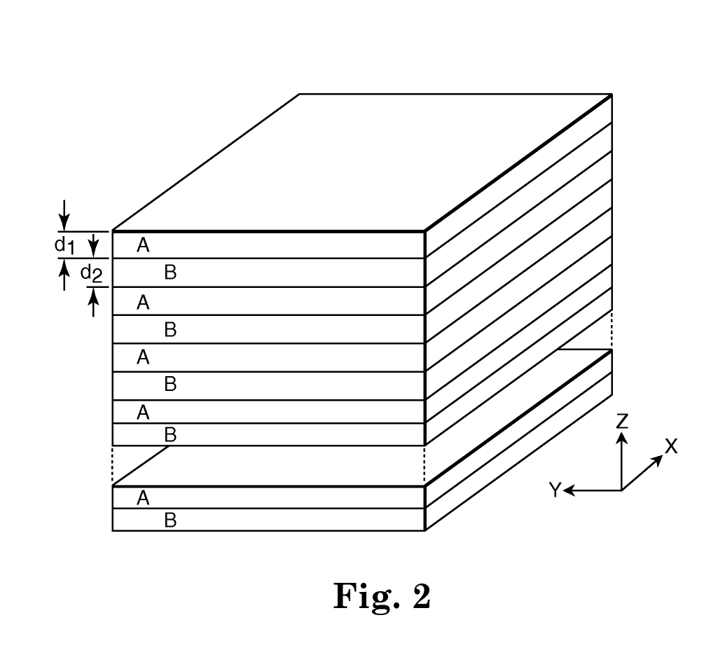

Multilayer polymeric films can include hundreds or thousands of thin layers, and may contain as many materials as there are layers in the stack. For ease of manufacturing, preferred multilayer films have only a few different materials, and for simplicity those discussed herein typically include only two. FIG. 2, for example, includes a first polymer A having an actual thickness d₁, and a second polymer B having an actual thickness d₂. The multilayer film includes alternating layers of a first polymeric material having a first index of refraction, and a second polymeric material having a second index of refraction that is different from that of the first material. The individual layers are typically on the order of 0.05 micrometers to 0.45 micrometers thick. As an example, the PCT Publication to Ouderkirk et al. discloses a multilayered polymeric film having alternating layers of crystalline naphthalene dicarboxylic acid polyester and another selected polymer, such as copolyester or copolycarbonate, wherein the layers have a thickness of less than 0.5 micrometers, and wherein the refractive indices of one of the polymers can be as high as 1.9 in one direction and 1.64 in the other direction, thereby providing a birefringent effect which is useful in the polarization of light.

Adjacent pairs of layers (one having a high index of refraction, and the other a low index) preferably have a total optical thickness that is ½ of the wavelength of the light desired to be reflected. For maximum reflectivity the individual layers of a multilayer polymeric film have an optical thickness that is ¼ of the wavelength of the light desired to be reflected, although other ratios of the optical thicknesses within the layer pairs may be chosen for other reasons. These preferred conditions are expressed in Equations 1 and 2, respectively. Note that optical thickness is defined as the refractive index of a material multiplied by the actual thickness of the material, and that unless stated otherwise, all actual thicknesses discussed herein are measured after any orientation or other processing. For biaxially oriented multilayer optical stacks at normal incidence, the following equation applies:
λ/2=t₁+t₂=n₁d₁+n₂d₂ Equation 1:
λ/4=t₁=t₂=n₁d₁=n₂d₂ Equation 2:
where X=wavelength of maximum light reflection
t₁=optical thickness of the first layer of material
t₂=optical thickness of the second layer of material and
n₁=in-plane refractive index of the first material
n₂=in-plane refractive index of the second material
d₁=actual thickness of the first material
d₂=actual thickness of the second material

By creating a multilayer film with layers having different optical thicknesses (for example, in a film having a layer thickness gradient), the film will reflect light of different wavelengths. An important feature is the selection of layers having desired optical thicknesses (by selecting the actual layer thicknesses and materials) sufficient to reflect light in the near IR portion of the spectrum. Moreover, because pairs of layers will reflect a predictable bandwidth of light, as described below, individual layer pairs may be designed and made to reflect a given bandwidth of light. Thus, if a large number of properly selected layer pairs are combined, superior reflectance of a desired portion of the near IR spectrum can be achieved, thus producing the clear-to-colored effect.

The bandwidth of light desired to be reflected at a zero degree observation angle is conveniently from approximately 720 to 900 nanometers. Thus, the layer pairs preferably have optical thicknesses ranging from 360 to 450 nanometers (½ the wavelength of the light desired to be reflected) in order to reflect the near IR light. More preferably, the multilayer film would have individual layers each having an optical thickness ranging from 180 to 225 nanometers (¼ the wavelength of the light desired to be reflected), in order to reflect the near infrared light. Assuming for purposes of illustration that the first layer material has a refractive index of 1.66 (as does biaxially oriented PET), and the second layer material has a refractive index of 1.52 (as does biaxially oriented ECDEL™), and assuming that both layers have the same optical thickness (¼ wavelength), then the actual thicknesses of the first material layers would range from approximately 108 to 135 nanometers, and the actual thicknesses of the second layers would range from approximately 118 to 148 nanometers. The optical properties of multilayer films such as this are discussed in detail below.

The various layers in the film preferably have different optical thicknesses. This is commonly referred to as the layer thickness gradient. A layer thickness gradient is selected to achieve the desired overall bandwidth of reflection. One common layer thickness gradient is a linear one, in which the optical thickness of the thickest layer pairs is a certain percent thicker than the optical thickness of the thinnest layer pairs. For example, a 1.13:1 layer thickness gradient means that the optical thickness of the thickest layer pair (typically adjacent one major surface) is 13% thicker than the optical thickness of the thinnest layer pair (typically adjacent the opposite surface of the film). In other embodiments, the optical thickness of the layers may increase or decrease linearly or otherwise, for example by having layers of monotonically decreasing optical thickness, then of monotonically increasing optical thickness, and then monotonically decreasing optical thickness again from one major surface of the film to the other. This is believed to provide sharper band edges, and thus a sharper or more abrupt transition from clear to colored in the case of the present invention. Other variations include discontinuities in optical thickness between two stacks of layers, curved layer thickness gradients, a reverse thickness gradient, a stack with a reverse thickness gradient with f-ratio deviation, and a stack with a substantially zero thickness gradient.

There are several factors to be considered in choosing the materials for the optical film of the tear strip. First, although the optical film may be made with three or more different types of polymers, alternating layers of a first polymer and a second polymer are preferred for manufacturing reasons. Second, one of the two polymers, referred to as the first polymer, must have a stress optical coefficient having a large absolute value. In other words, it must be capable of developing a large birefringence when stretched. Depending on the application, this birefringence may be developed between two orthogonal directions in the plane of the film, between one or more in-plane directions and the direction perpendicular to the film plane, or a combination of these. Third, the first polymer must be capable of maintaining this birefringence after stretching, so that the desired optical properties are imparted to the finished film. Fourth, the other required polymer, referred to as the second polymer, must be chosen so that in the finished film, its refractive index, in at least one direction, differs significantly from the index of refraction of the first polymer in the same direction. Because polymeric materials are dispersive, that is, the refractive indices vary with wavelength, these conditions must be considered in terms of a spectral bandwidth of interest. Absorbance is another consideration. It is generally advantageous for neither the first polymer nor the second polymer to have any absorbance bands within the bandwidth of interest. Thus, all incident light within the bandwidth is either reflected or transmitted. However, it may also be useful for one or both of the first and second polymer to absorb specific wavelengths, either totally or in part.

Polyethylene 2,6-naphthalate (PEN) is frequently chosen as a first polymer for films of the present invention, for reasons explained in greater detail below. It has a large positive stress optical coefficient, retains birefringence effectively after stretching, and has little or no absorbance within the visible range. It also has a large index of refraction in the isotropic state. Its refractive index for polarized incident light of 550 nm wavelength increases when the plane of polarization is parallel to the stretch direction from about 1.64 to as high as about 1.9. Its birefringence can be increased by increasing its molecular orientation which, in turn, may be increased by stretching to greater stretch ratios with other stretching conditions held fixed.

Other semicrystalline naphthalene dicarboxylic polyesters are also suitable as first polymers. Polybutylene 2,6-Naphthalate (PBN) is an example. These polymers may be homopolymers or copolymers, provided that the use of comonomers does not substantially impair the stress optical coefficient or retention of birefringence after stretching. The term “PEN” herein will be understood to include copolymers of PEN meeting these restrictions. In practice, these restrictions impose an upper limit on the comonomer content, the exact value of which will vary with the choice of comonomer(s) employed. Some compromise in these properties may be accepted, however, if comonomer incorporation results in improvement of other properties. Such properties include but are not limited to improved interlayer adhesion, lower melting point (resulting in lower extrusion temperature), better rheological matching to other polymers in the film, and advantageous shifts in the process window for stretching due to change in the glass transition temperature.

Suitable comonomers for use in PEN, PBN or the like may be of the diol or dicarboxylic acid or ester type. Dicarboxylic acid comonomers include but are not limited to terephthalic acid, isophthalic acid, phthalic acid, all isomeric naphthalenedicarboxylic acids (2,6-, 1,2-, 1,3-, 1,4-, 1,5-, 1,6-, 1,7-, 1,8-, 2,3-, 2,4-, 2,5-, 2,7-, and 2,8-), bibenzoic acids such as 4,4′-biphenyl dicarboxylic acid and its isomers, trans-4,4′-stilbene dicarboxylic acid and its isomers, 4,4′-diphenyl ether dicarboxylic acid and its isomers, 4,4′-diphenylsulfone dicarboxylic acid and its isomers, 4,4′-benzophenone dicarboxylic acid and its isomers, halogenated aromatic dicarboxylic acids such as 2-chloroterephthalic acid and 2,5-dichloroterephthalic acid, other substituted aromatic dicarboxylic acids such as tertiary butyl isophthalic acid and sodium sulfonated isophthalic acid, cycloalkane dicarboxylic acids such as 1,4-cyclohexanedicarboxylic acid and its isomers and 2,6-decahydronaphthalene dicarboxylic acid and its isomers, bi- or multi-cyclic dicarboxylic acids (such as the various isomeric norbornane and norbornene dicarboxylic acids, adamantane dicarboxylic acids, and bicyclo-octane dicarboxylic acids), alkane dicarboxylic acids (such as sebacic acid, adipic acid, oxalic acid, malonic acid, succinic acid, glutaric acid, azelaic acid, and dodecane dicarboxylic acid.), and any of the isomeric dicarboxylic acids of the fused-ring aromatic hydrocarbons (such as indene, anthracene, pheneanthrene, benzonaphthene, fluorene and the like). Alternatively, alkyl esters of these monomers, such as dimethyl terephthalate, may be used.

Suitable diol comonomers include but are not limited to linear or branched alkane diols or glycols (such as ethylene glycol, propanediols such as trimethylene glycol, butanediols such as tetramethylene glycol, pentanediols such as neopentyl glycol, hexanediols, 2,2,4-trimethyl-1,3-pentanediol and higher diols), ether glycols (such as diethylene glycol, triethylene glycol, and polyethylene glycol), chain-ester diols such as 3-hydroxy-2,2-dimethylpropyl-3-hydroxy-2,2-dimethyl propanoate, cycloalkane glycols such as 1,4-cyclohexanedimethanol and its isomers and 1,4-cyclohexanediol and its isomers, bi- or multicyclic diols (such as the various isomeric tricyclodecane dimethanols, norbornane dimethanols, norbornene dimethanols, and bicyclo-octane dimethanols), aromatic glycols (such as 1,4-benzenedimethanol and its isomers, 1,4-benzenediol and its isomers, bisphenols such as bisphenol A, 2,2′-dihydroxy biphenyl and its isomers, 4,4′-dihydroxymethyl biphenyl and its isomers, and 1,3-bis(2-hydroxyethoxy)benzene and its isomers), and lower alkyl ethers or diethers of these diols, such as dimethyl or diethyl diols.

Tri- or polyfunctional comonomers, which can serve to impart a branched structure to the polyester molecules, can also be used. They may be of either the carboxylic acid, ester, hydroxy or ether types. Examples include, but are not limited to, trimellitic acid and its esters, trimethylol propane, and pentaerythritol.

Also suitable as comonomers are monomers of mixed functionality, including hydroxycarboxylic acids such as parahydroxybenzoic acid and 6-hydroxy-2-naphthalenecarboxylic acid, and their isomers, and tri- or polyfunctional comonomers of mixed functionality such as 5-hydroxyisophthalic acid and the like.

Polyethylene terephthalate (PET) is another material that exhibits a significant positive stress optical coefficient, retains birefringence effectively after stretching, and has little or no absorbance within the visible range. Thus, it and its high PET-content copolymers employing comonomers listed above may also be used as first polymers in some applications of the current invention.

When a naphthalene dicarboxylic polyester such as PEN or PBN is chosen as first polymer, there are several approaches which may be taken to the selection of a second polymer. One preferred approach for some applications is to select a naphthalene dicarboxylic copolyester (coPEN) formulated so as to develop significantly less or no birefringence when stretched. This can be accomplished by choosing comonomers and their concentrations in the copolymer such that crystallizability of the coPEN is eliminated or greatly reduced. One typical formulation employs as the dicarboxylic acid or ester components dimethyl naphthalate at from about 20 mole percent to about 80 mole percent and dimethyl terephthalate or dimethyl isophthalate at from about 20 mole percent to about 80 mole percent, and employs ethylene glycol as diol component. Of course, the corresponding dicarboxylic acids may be used instead of the esters. The number of comonomers which can be employed in the formulation of a coPEN second polymer is not limited. Suitable comonomers for a coPEN second polymer include but are not limited to all of the comonomers listed above as suitable PEN comonomers, including the acid, ester, hydroxy, ether, tri- or polyfunctional, and mixed functionality types.

Often it is useful to predict the isotropic refractive index of a coPEN second polymer. A volume average of the refractive indices of the monomers to be employed has been found to be a suitable guide. Similar techniques well-known in the art can be used to estimate glass transition temperatures for coPEN second polymers from the glass transitions of the homopolymers of the monomers to be employed.

In addition, polycarbonates having a glass transition temperature compatible with that of PEN and having a refractive index similar to the isotropic refractive index of PEN are also useful as second polymers. Polyesters, copolyesters, polycarbonates, and copolycarbonates may also be fed together to an extruder and transesterified into new suitable copolymeric second polymers.

It is not required that the second polymer be a copolyester or copolycarbonate. Vinyl polymers and copolymers made from monomers such as vinyl naphthalenes, styrenes, ethylene, maleic anhydride, acrylates, acetates, and methacrylates may be employed. Condensation polymers other than polyesters and polycarbonates may also be used. Examples include polysulfones, polyamides, polyurethanes, polyamic acids, and polyimides. Naphthalene groups and halogens such as chlorine, bromine and iodine are useful for increasing the refractive index of the second polymer to a desired level. Acrylate groups and fluorine are particularly useful in decreasing refractive index when this is desired.

It will be understood from the foregoing discussion that the choice of a second polymer is dependent not only on the intended application of the multilayer optical film in question, but also on the choice made for the first polymer, and the processing conditions employed in stretching. Suitable second polymer materials include but are not limited to polyethylene naphthalate (PEN) and isomers thereof (such as 2,6-, 1,4-, 1,5-, 2,7-, and 2,3-PEN), polyalkylene terephthalates (such as polyethylene terephthalate, polybutylene terephthalate, and poly-1,4-cyclohexanedimethylene terephthalate), other polyesters, polycarbonates, polyarylates, polyamides (such as nylon 6, nylon 11, nylon 12, nylon 4/6, nylon 6/6, nylon 6/9, nylon 6/10, nylon 6/12, and nylon 6/T), polyimides (including thermoplastic polyimides and polyacrylic imides), polyamide-imides, polyether-amides, polyetherimides, polyaryl ethers (such as polyphenylene ether and the ring-substituted polyphenylene oxides), polyarylether ketones such as polyetheretherketone (“PEEK”), aliphatic polyketones (such as copolymers and terpolymers of ethylene and/or propylene with carbon dioxide), polyphenylene sulfide, polysulfones (including polyethersulfones and polyaryl sulfones), atactic polystyrene, syndiotactic polystyrene (“sPS”) and its derivatives (such as syndiotactic poly-alpha-methyl styrene and syndiotactic polydichlorostyrene), blends of any of these polystyrenes (with each other or with other polymers, such as polyphenylene oxides), copolymers of any of these polystyrenes (such as styrene-butadiene copolymers, styrene-acrylonitrile copolymers, and acrylonitrile-butadiene-styrene terpolymers), polyacrylates (such as polymethyl acrylate, polyethyl acrylate, and polybutyl acrylate), polymethacrylates (such as polymethyl methacrylate, polyethyl methacrylate, polypropyl methacrylate, and polyisobutyl methacrylate), cellulose derivatives (such as ethyl cellulose, cellulose acetate, cellulose propionate, cellulose acetate butyrate, and cellulose nitrate), polyalkylene polymers (such as polyethylene, polypropylene, polybutylene, polyisobutylene, and poly(4-methyl)pentene), fluorinated polymers and copolymers (such as polytetrafluoroethylene, polytrifluoroethylene, polyvinylidene fluoride, polyvinyl fluoride, fluorinated ethylene-propylene copolymers, perfluoroalkoxy resins, polychlorotrifluoroethylene, polyethylene-co-trifluoroethylene, polyethylene-co-chlorotrifluoroethylene), chlorinated polymers (such as polyvinylidene chloride and polyvinyl chloride), polyacrylonitrile, polyvinylacetate, polyethers (such as polyoxymethylene and polyethylene oxide), ionomeric resins, elastomers (such as polybutadiene, polyisoprene, and neoprene), silicone resins, epoxy resins, and polyurethanes.

Also suitable are copolymers, such as the copolymers of PEN discussed above as well as any other non-naphthalene group-containing copolyesters which may be formulated from the above lists of suitable polyester comonomers for PEN. In some applications, especially when PET serves as the first polymer, copolyesters based on PET and comonomers from said lists above (coPETs) are especially suitable. In addition, either first or second polymers may consist of miscible or immiscible blends of two or more of the above-described polymers or copolymers (such as blends of sPS and atactic polystyrene, or of PEN and sPS). The coPENs and coPETs described may be synthesized directly, or may be formulated as a blend of pellets where at least one component is a polymer based on naphthalene dicarboxylic acid or terephthalic acid and other components are polycarbonates or other polyesters, such as a PET, a PEN, a coPET, or a co-PEN.

Another preferred family of materials for the second polymer are the syndiotactic vinyl aromatic polymers, such as syndiotactic polystyrene. Syndiotactic vinyl aromatic polymers useful in the current invention include poly(styrene), poly(alkyl styrene)s, poly (aryl styrene)s, poly(styrene halide)s, poly(alkoxy styrene)s, poly(vinyl ester benzoate), poly(vinyl naphthalene), poly(vinylstyrene), and poly(acenaphthalene), as well as the hydrogenated polymers and mixtures or copolymers containing these structural units. Examples of poly(alkyl styrene)s include the isomers of the following: poly(methyl styrene), poly(ethyl styrene), poly(propyl styrene), and poly(butyl styrene). Examples of poly(aryl styrene)s include the isomers of poly(phenyl styrene). As for the poly(styrene halide)s, examples include the isomers of the following: poly(chlorostyrene), poly(bromostyrene), and poly(fluorostyrene). Examples of poly(alkoxy styrene)s include the isomers of the following: poly(methoxy styrene) and poly(ethoxy styrene). Among these examples, particularly preferable styrene group polymers, are: polystyrene, poly(p-methyl styrene), poly(m-methyl styrene), poly(p-tertiary butyl styrene), poly(p-chlorostyrene), poly(m-chloro styrene), poly(p-fluoro styrene), and copolymers of styrene and p-methyl styrene.

Furthermore, comonomers may be used to make syndiotactic vinyl aromatic group copolymers. In addition to the monomers for the homopolymers listed above in defining the syndiotactic vinyl aromatic polymers group, suitable comonomers include olefin monomers (such as ethylene, propylene, butenes, pentenes, hexenes, octenes or decenes), diene monomers (such as butadiene and isoprene), and polar vinyl monomers (such as cyclic diene monomers, methyl methacrylate, maleic acid anhydride, or acrylonitrile). The syndiotactic vinyl aromatic copolymers of the present invention may be block copolymers, random copolymers, or alternating copolymers.

The syndiotactic vinyl aromatic polymers and copolymers referred to in this invention generally have syndiotacticity of higher than 75% or more, as determined by carbon-13 nuclear magnetic resonance. Preferably, the degree of syndiotacticity is higher than 85% racemic diad, or higher than 30%, or more preferably, higher than 50%, racemic pentad. In addition, although there are no particular restrictions regarding the molecular weight of these syndiotactic vinyl aromatic polymers and copolymers, preferably, the weight average molecular weight is greater than 10,000 and less than 1,000,000, and more preferably, greater than 50,000 and less than 800,000.

The syndiotactic vinyl aromatic polymers and copolymers may also be used in the form of polymer blends with, for instance, vinyl aromatic group polymers with atactic structures, vinyl aromatic group polymers with isotactic structures, and any other polymers that are miscible with the vinyl aromatic polymers. For example, polyphenylene ethers show good miscibility with many of the previous described vinyl aromatic group polymers.

Particularly preferred combinations of polymers for optical layers in the case of color-shifting films include PEN/PMMA, PET/PMMA, PEN/Ecdel™, PET/Ecdel™, PEN/sPS, PET/sPS, PEN/coPET, PEN/PETG, and PEN/THV™, where “PMMA” refers to polymethyl methacrylate, Ecdel™ is a copolyester ether elastomer commercially available from Eastman Chemical Co., “coPET” refers to a copolymer or blend based upon terephthalic acid (as described above), “PETG” refers to a copolymer of PET employing a second glycol (usually cyclohexanedimethanol), and THV™ is a fluoropolymer commercially available from 3M.

It is sometimes preferred for the multilayer optical films of the tear strip to consist of more than two distinguishable polymers. A third or subsequent polymer might be fruitfully employed as an adhesion-promoting layer between the first polymer and the second polymer within an optical stack, as an additional component in a stack for optical purposes, as a protective boundary layer between optical stacks, as a skin layer, as a functional coating, or for any other purpose. As such, the composition of a third or subsequent polymer, if any, is not limited. Each skin layer, which are typically provided as outermost layers for a multilayer optical film or a set of layers comprising an optical film, typically has a physical thickness between 1% and 40%, and preferably between 5% and 20% of the overall physical thickness of the multilayer film.

The reflectance characteristics of multilayer films are determined by several factors, the most important of which for purposes of this discussion are the indices of refraction for each layer of the film stack. In particular, reflectivity depends upon the relationship between the indices of refraction of each material in the x, y, and z directions (nₓ, n_{y}, n_{z}). Different relationships between the three indices lead to three general categories of materials: isotropic, uniaxially birefringent, and biaxially birefringent. The latter two are important to the optical performance of the tear strip.

In a uniaxially birefringent material, two indices (typically along the x and y axes, or nₓ and n_{y}) are equal, and different from the third index (typically along the z axis, or n_{z}). The x and y axes are defined as the in-plane axes, in that they represent the plane of a given layer within the multilayer film, and the respective indices nₓ and n_{y} are referred to as the in-plane indices.

One method of creating a uniaxially birefringent system is to biaxially orient (stretch along two axes) a multilayer polymeric film. Biaxial orientation of the multilayer film results in differences between refractive indices of adjoining layers for planes parallel to both axes, resulting in the reflection of light in both planes of polarization. A uniaxially birefringent material can have either positive or negative uniaxial birefringence. Positive uniaxial birefringence occurs when the index of refraction in the z direction (n_{z}) is greater than the in-plane indices (nₓ and n_{y}). Negative uniaxial birefringence occurs when the index of refraction in the z direction (n_{z}) is less than the in-plane indices (nₓ and n_{y}). It can be shown that when n_{1z} is selected to match n₂ₓ=n_{2y}=n_{2z} and the multilayer film is biaxially oriented, there is no Brewster's angle for p-polarized light and thus there is constant reflectivity for all angles of incidence. In other words, properly designed multilayer films that are oriented in two mutually perpendicular in-plane axes reflect an extraordinarily high percentage of incident light, and are highly efficient mirrors. By selecting the layers as previously described to reflect near IR light, the color shifting effect of the film of the present invention may be obtained. This same effect may be achieved by positioning two uniaxially oriented (biaxially oriented) films, discussed below, with their respective orientation axes at 90° to each other.

In a biaxially birefringent material, all three indices are different. A biaxially birefringent system can be made by uniaxially orienting (stretching along one axis) the multilayer polymeric film, such as along the x direction in FIG. 2. A biaxially birefringent multilayer film can be designed to provide high reflectivity for light with its plane of polarization parallel to one axis, for all angles of incidence, and simultaneously have low reflectivity (high transmissivity) for light with its plane of polarization parallel to the other axis at all angles of incidence. As a result, the biaxially birefringent system acts as a polarizer, reflecting light of one polarization and transmitting light of the other polarization. Stated differently, a polarizing film is one that receives incident light of random polarity (light vibrating in planes at random angles), and allows incident light rays of one polarity (vibrating in one plane) to pass through the film, while reflecting incident light rays of the other polarity (vibrating in a plane perpendicular to the first plane). By controlling the three indices of refraction—nₓ, n_{y}, and n_{z}—the desired polarizing effects can be obtained. If the layers were appropriately designed to reflect light in the near infrared, a clear to colored polarizer is the result. Used alone, this film would appear substantially clear at angles less than the shift angle, and colored (although only about half as intense as the biaxially oriented mirror film) at angles exceeding the shift angle. When viewed through a polarizer, it appears clear to either polarizer orientation at angles below the shift angle. For angles greater than the shift angle, it is deeply colored for the light polarized parallel to the stretch direction and clear for light polarized parallel to the non-stretch direction. It is desirable to have n₁ₓ>n₂ₓ, and n_{1y} approximately equal to n_{2y} and n_{1z} closer to n₂ₓ than n₁ₓ for efficient reflection of light of only one plane of polarization and desired color shift. Two crossed sheets of biaxially birefringent film would yield a highly efficient mirror, and the films would perform similar to a single uniaxially birefringent film.

Another way of making multilayer polymeric polarizers using biaxial orientation is as follows. Two polymers capable of permanent birefringence are drawn sequentially such that in the first draw, the conditions are chosen to produce little birefringence in one of the materials, and considerable birefringence in the other. In the second draw, the second material develops considerable birefringence, sufficient to match the final refractive index of the first material in that direction. Often the first material assumes an in-plane biaxial character after the second draw. An example of a system that produces a good polarizer from biaxial orientation is PEN/PET. In that case, the indices of refraction can be adjusted over a range of values. The following set of values demonstrates the principle: for PEN, n₁ₓ=1.68, n_{1y}=1.82, n_{1z}=1.49; for PET n₁ₓ=1.67, n_{1y}=1.56 and n_{1z}=1.56, all at 632.8 nm. Copolymers of PEN and PET may also be used. For example, a copolymer comprising approximately 10% PEN subunits and 90% PET subunits by weight may replace the PET homopolymer in the construction. Indices for the copolymer under similar processing are about n₁ₓ=1.67, n_{1y}=1.62, n_{1z}=1.52, at 632.8 nm. There is a good match of refractive indices in the x direction, a large difference (for strong reflection) in the y direction, and a small difference in the z direction. This small z index difference minimizes unwanted color leaks at shallow observation angles. The film formed by biaxial orientation is strong in all planar directions, while uniaxially oriented polarizer is prone to splitting.

The foregoing is meant to be exemplary, and it will be understood that combinations of these and other techniques may be employed to achieve the polarizing film goal of index mismatch in one in-plane direction and relative index matching in the orthogonal planar direction.

The clear to colored multilayer film of the tear strip reflects red light at angles greater than the shift angle. Because cyan is by definition the subtraction of red light from white light, the film appears cyan. The amount of red light reflected, and thus the degree to which the film appears cyan, depends on the observation angle and the reflected bandwidth. As shown in FIG. 1, the observation angle is measured between the photoreceptor (typically a human eye) and the observation axis perpendicular to the plane of the film. When the observation angle is approximately zero degrees, very little visible light of any color is reflected by the multilayer film, and the film appears clear against a diffuse white background (or black against a black background). When the observation angle exceeds a predetermined shift angle α, a substantial portion of the red light is reflected by the multilayer film, and the film appears cyan against a diffuse white background (or red against a black background). As the observation angle increases toward 90 degrees, more red light is reflected by the multilayer film, and the cyan appears to be even deeper. The foregoing description is based on the observation of the effect of ambient diffuse white light on the film, rather than on a collimated beam of light. For the case of a single collimated light source with the film viewed against a diffuse white background, the effect is quite similar, except for the special case where the angle of specular reflectance is the observation angle. When this occurs, for angles greater then the shift angle, red light reaches the photoreceptor. By moving the observation angle slightly away from the angle of specular reflectance, the cyan color is again observed. If a narrow reflectance band is used, red light will transit through the film again at shallow viewing angles (greater than the shift angle and less than 90 degrees). This will give a magenta hue to the film. So a clear film would change to cyan, then magenta as the viewer changes observation angle from 0 to 90 degrees. The reflectance band should be less than 100 nm wide to achieve this effect.

One common description of reflectance bandwidth depends on the relationship between the in-plane indices of refraction of the materials in the stack, as shown by the following equation:
Bandwidth=(4λ/π)sin⁻¹ [(1−(n₂/n₁))/(1+(n₂/n₁))] Equation 3:
Thus, if n₁ is close to n₂, the reflectance peak is very narrow. For example, in the case of a multilayer film having alternating layers of PET (n₁=1.66) and Ecdel (n₂=1.52) of the same optical thickness, selected for λ=750 nm minimum transmission, the breadth or bandwidth of the transmission minimum is about 42 nm. In the case of a multilayer film having alternating layers of PEN (n₁=1.75) and PMMA (n₂=1.49) under the same conditions, the bandwidth is 77 nm.

The value of the blue shift with angle of incidence in any thin film stack can be derived from the basic wavelength tuning formula for an individual layer, shown as Equation 4, below:
λ/4=nd(Cos θ) Equation 4:
where
λ=wavelength tuned to the given layer;
n=index of refraction for the material layer for the given direction and polarization of the light traveling through the layer;
d=actual thickness of the layer; and
θ=angle of incidence measured from perpendicular in that layer.

In an isotropic thin film stack, only the value of (Cos θ) decreases as θ increases. However, in the films for use in the tear strip, both n and (Cos θ) decrease for p-polarized light as θ increases. When the unit cell includes one or more layers of a negatively birefringent material such as PEN, the p-polarized light senses the low z-index value instead of only the in-plane value of the index, resulting in a reduced effective index of refraction for the negatively birefringent layers. Accordingly, the effective low z-index caused by the presence of negatively birefringent layers in the unit cell creates a secondary blue shift in addition to the blue shift present in an isotropic thin stack. The compounded effects result in a greater blue shift of the spectrum compared to film stacks composed entirely of isotropic materials. The actual blue shift will be determined by the thickness weighted average change in L with angle of incidence for all material layers in the unit cell. Thus, the blue shift can be enhanced or lessened by adjusting the relative thickness of the birefringent layer(s) to the isotropic layer(s) in the unit cell. This will result in changes in the f-ratio, defined below, that must first be considered in the product design. The maximum blue shift in mirrors is attained by using negatively uniaxially birefringent materials in all layers of the stack. The minimum blue shift is attained by using only uniaxially positive birefringent materials in the optical stack. For polarizers, biaxially birefringent materials are used, but for the simple case of light incident along one of the major axes of a birefringent thin film polarizer, the analysis is the same for both uniaxial and biaxial films. For directions between the major axes of a polarizer, the effect is still observable but the analysis is more complex.

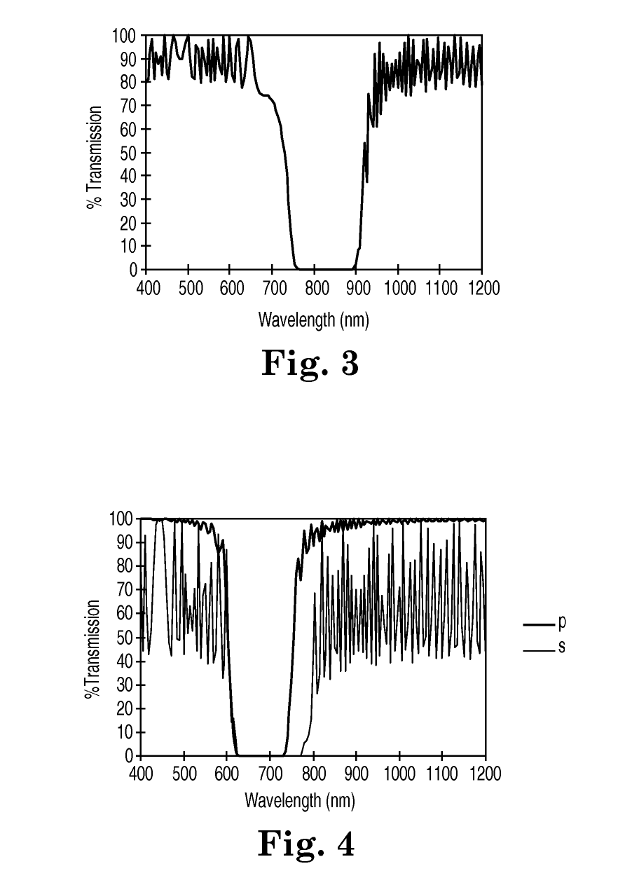

For the uniaxially birefringent case of PEN/PMMA, the angular dependence of the red light reflectance is illustrated in FIGS. 3 and 4. In those graphs, the percent of transmitted light is plotted along the vertical axis, and the wavelengths of light are plotted along the horizontal axis. Note that because the percentage of light transmitted is simply 1 minus the percentage of light reflected (absorption is negligible), information about light transmission also provides information about light reflection. The spectra provided in FIGS. 3 and 4 are taken from a computerized optical modeling system, and actual performance typically corresponds relatively closely with predicted performance. Surface reflections contribute to a decreased transmission in both the computer modeled and measured spectra. In other Examples for which actual samples were tested, a spectrometer available from the Perkin Elmer Corporation of Norwalk, Conn. under the designation Lambda 19 was used to measure optical transmission of light at the angles indicated.

A uniaxially birefringent film having a total of 224 alternating layers of PEN (n_{x,y}=1.75; n_{z}=1.5) and PMMA (n_{x,y,z}=1.5) with a linear layer thickness gradient of 1.13:1 was modeled. The transmission spectra for this modeled film at a zero degree observation angle is shown in FIG. 3, and the transmission spectra at a 60 degree observation angle is shown in FIG. 4. FIG. 3 shows the virtual extinction of near-IR light, resulting in a film that appears clear to an observer. FIG. 4 shows the virtual extinction of red light, resulting in a film that appears cyan to an observer. Note also that the low (or left) wavelength band edge for both the s- and p-polarized light shift together from about 750 nm to about 600 nm, and transmission is minimized in the desired range of the spectrum so that to the eye, a very sharp color shift is achieved. The concurrent shift of the s- and p-polarized light is a desirable aspect of the present invention, because the color shift is more abrupt and dramatic when light of both polarities shift together. In FIGS. 3 and 4, as well as in later Figures, this effect may be observed by determining whether the left band edges of the s- and p-polarized light spectra are spaced apart or not.

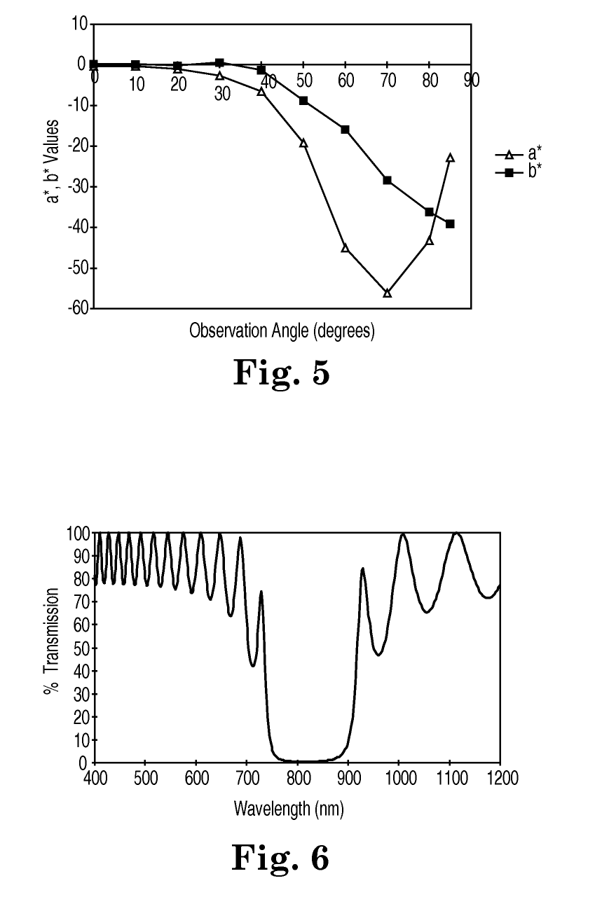

To determine the actual color of the film modeled above, the CIE color coordinates in L*a*b color space were determined for transmitted light and a* and b* were plotted as a function of observation angle in FIG. 5. The color calculation method followed ASTM E308-95 “Standard Practice for Computing the Colors of Objects by Using the CIE System”. For the CIE calculations on actual spectra, the data was generated following method ASTM E1164-94 “Standard Practice for Obtaining Spectrophotometric Data for Object-Color Evaluation. Illuminant D65 with a 10 degree supplementary standard observer is used for all CIE color measurements. The transmission spectra for the films are used in throughout, although our modeling shows slight differences when CIE coordinates are calculated as two transmissions and a reflection from a white diffuse background. In CIE color coordinates, positive a* corresponds to red, negative a* to green, positive b* to yellow and negative b* to blue color. A*=b*=0 is totally colorless. The colorless condition in Yxy color space is x=0.3127 and y=0.3290. In practice, when the absolute values of a*, b*<1, the human eye cannot perceive any color, and when the absolute values of a*, b*<5, the films of this invention are substantially colorless. Note in FIG. 5 that beyond the shift angle (about 36 degrees), a dramatic change from essentially colorless to a deep cyan occurs. The a* shifts to values lower than −40 and b* achieves values lower than −30 at observation angles of 72 degrees and beyond.

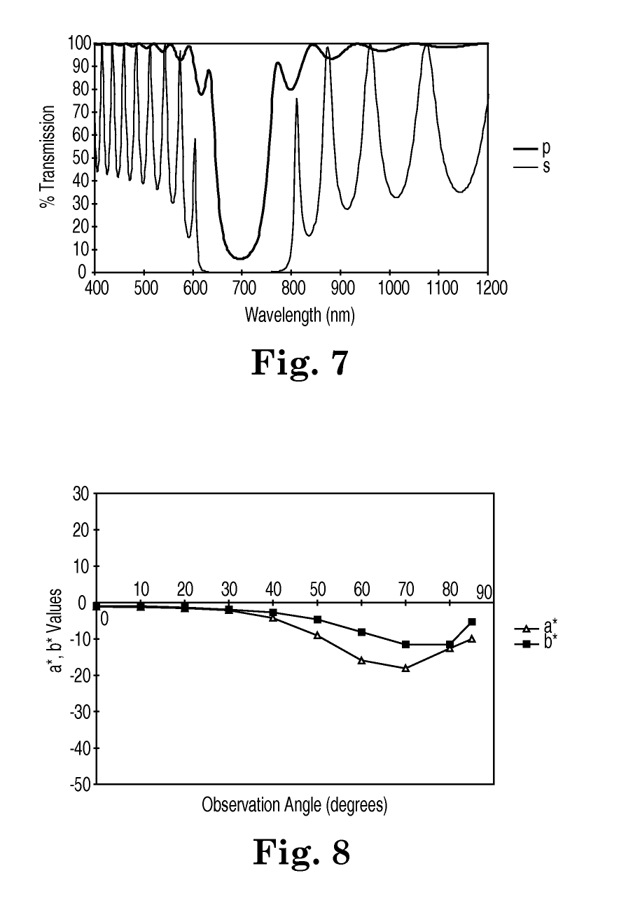

The present invention stands in contrast to the case of isotropic materials. For example, a 24 layer construction of zirconia and silica were modeled. The refractive index of zirconia was n_{x,y,z}=1.93, the refractive index of silica was n_{x,y,z}=1.45, and the model assumed a linear layer thickness gradient in which the thickest layer pair was 1.08 times thicker than the thinnest layer pair. At a zero degree observation angle, the isotropic film's spectra looked similar to the modeled multilayer film above (compare FIG. 6 to FIG. 3), and to the naked eye, both would be clear. As shown in FIG. 7, however, the low wavelength band edge for p-polarized light viewed at a 60 degree observation angle shifts by about 100 nm, while that for s-polarized light shifts by about 150 nm. This construction does not exhibit an abrupt change from clear to cyan because the s- and p-polarized light do not shift together with change in angle. Furthermore, the p-polarized light transmission spectrum shows some red light leakage, making for weaker cyan color saturation. The CIE color coordinates graphed in FIG. 8 for this modeled isotropic construction bear this out. The a* and b* values at the point of strongest coloration (an observation angle of about 70 degrees) only lie between about −10 and −20.

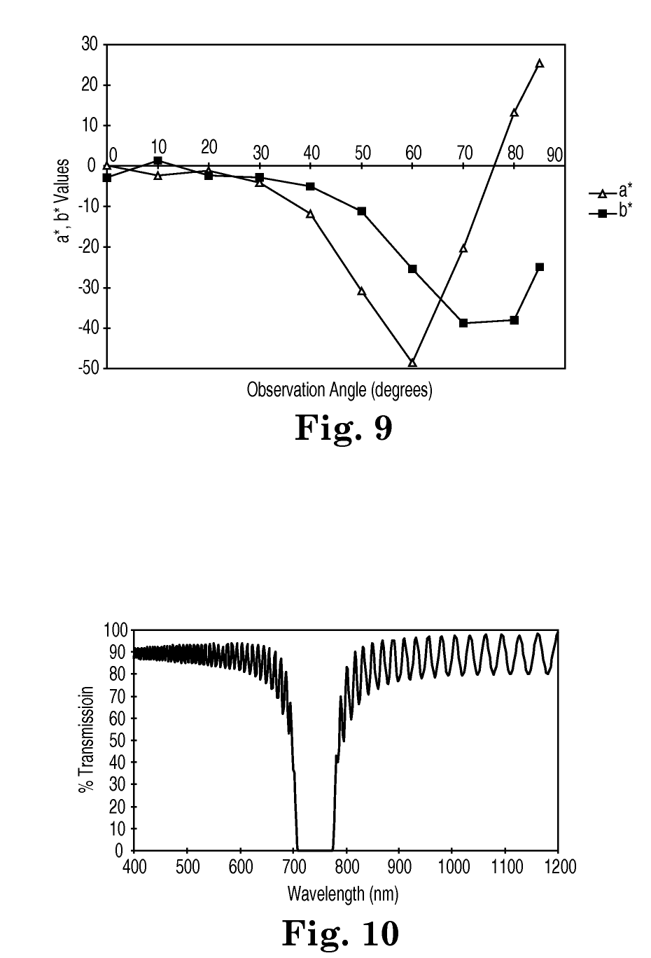

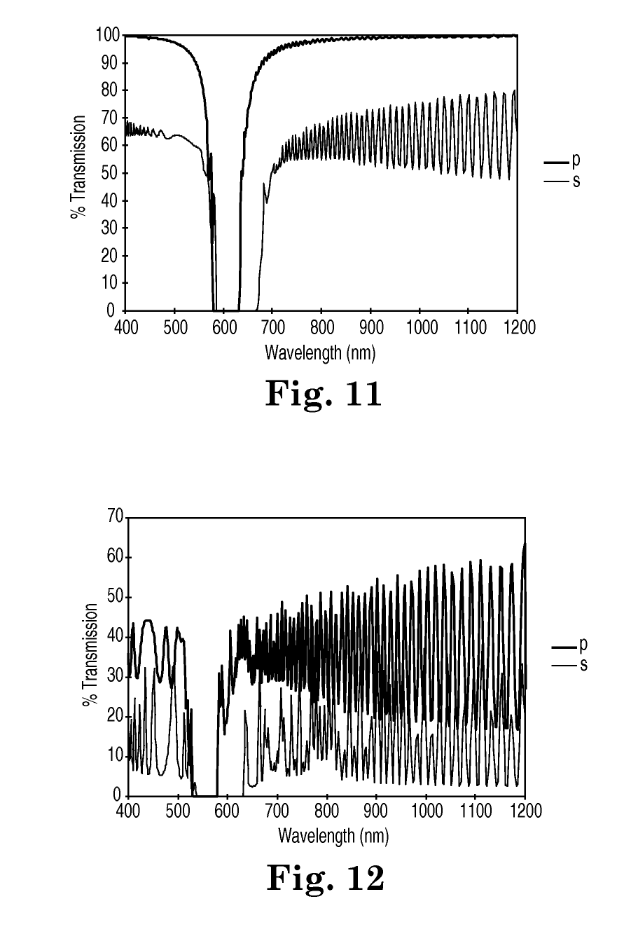

It is also possible with the films of tear strip to produce a film that appears to change color from clear to cyan to magenta. A 100 layer film was modeled using PEN and PMMA. The refractive indices employed in the model are n_{x,y}=1.75 and n_{z}=1.50 for PEN and n_{x,y,z}=1.50 for PMMA. Constant values of the refractive indices were used across the modeled spectrum from 350 to 1200 nm. The actual layer thickness was chosen to be 123.3 nm for PMMA and 105.7 nm for PEN, corresponding to a quarter wave stack centered at 740 nm. No layer thickness errors were employed in the model. The CIE color coordinates under transmitted light were determined for observation angles ranging from 0 to 85 degrees, and are shown in FIG. 9. The film appears clear at observation angles of less than about 30 degrees, then cyan (negative a* and negative b*) at observation angles of from about 40 to 70 degrees, and finally magenta (positive a* and negative b*) at observation angles of greater than 80 degrees. The corresponding spectra for this modeled construction are shown in FIGS. 10 through 12. The film appears clear in transmission at a zero degree observation angle (FIG. 10), because only near-IR light is reflected. At a 60 degree observation angle (FIG. 11), the film appears cyan because red light is reflected. At an 85 degree observation angle (FIG. 12), the transmission trough has shifted far enough to the left to allow roughly equal amounts of red and blue light to be transmitted, and the film appears magenta.

Shift angles of between 15 and 75 degrees are preferred, because if the shift angle is smaller that 15 degrees, the observer must carefully position the article to which the multilayer film is attached to obtain the clear appearance and perceive the underlying information. If the shift angle is larger than 75 degrees, the observer may not properly position the article to perceive the color shift, and thus may falsely perceive the article to be a counterfeit when it is not.

Shift angles of between 30 and 60 degrees are most preferred. The shift angle of a given multilayer film may be selected by designing the layer thicknesses so that a sufficient amount of red light is reflected to render the film cyan in appearance. The appropriate layer thicknesses may be estimated in accordance with Equations 1, 2 and 3 above, which relate the optical thickness (and therefore actual thickness) of the layers to the wavelengths of light desired to be reflected. The bandwidth for a given pair of materials may be estimated from Equation 3, multiplying by the layer thickness ratio. The center of the reflectance band is calculated from Equations 1 or 2 so that it is positioned approximately one half bandwidth from the desired location of the lower band edge.

The shift angle may be defined as the angle when a* first reaches a value of −5 on the CIE L*a*b color space. This also corresponds with the first angle where a noticeable amount of red light is reflected. As seen in FIGS. 3 and 5 compared to FIGS. 9 and 10, placing the transmission trough (reflectance peak) closer to the edge of the visible spectrum (700 nm) changes the shift angle from about 36 degrees to about 32 degrees. When this definition of shift angle is used, the lower band edges for s- and p-polarized light occur at about 660 nm for the PEN/PMMA modeled spectra. In the case of the modeled isotropic zirconia/silica construction, the shift angle occurs at 42° and the band edges fall at 650 nm for p-polarized light and 670 nm for s-polarized light.

To obtain the sharpest transition from clear to colored in appearance, the lower (or left) band edges for both s- and p-polarized light should be coincident. It is believed that one way to design a multilayer film in which those band edges are coincident is to choose materials with an f-ratio of approximately 0.25. The f-ratio, usually used to describe the f-ratio of the birefringent layer, is calculated as shown in Equation 5:
f-ratio=n₁d₁/(n₁d₁+n₂d₂) Equation 5:
where n and d are the refractive index and the actual thickness of the layers, respectively.

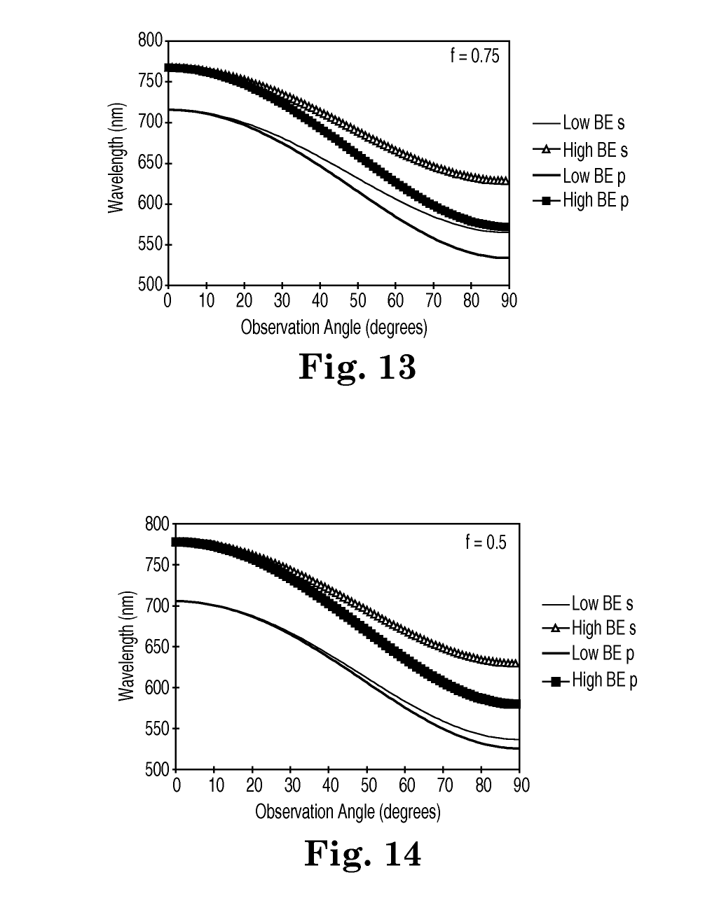

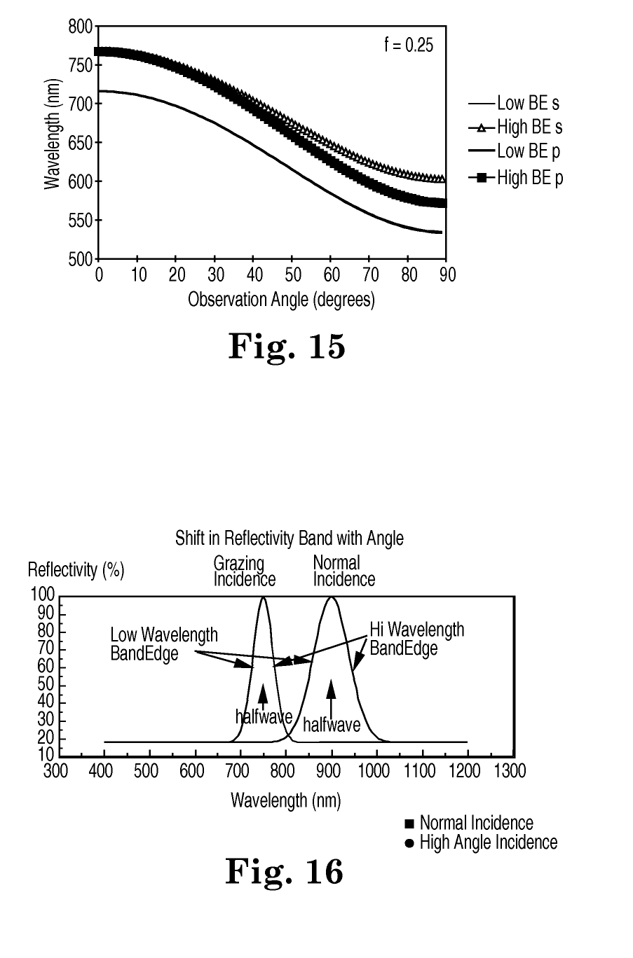

The 100 layer PEN/PMMA modeled case described above, and the subject of FIGS. 9 through 12, was used to demonstrate the effect of changing the f-ratio. PEN is the first material in equation 5; PMMA is the second material. When the f-ratio of the birefringent layer is approximately 0.75, there is a significant separation between the lower band edges of the s- and p-polarized light spectra, as shown in FIG. 13. When the f-ratio is approximately 0.5, there remains a noticeable separation, as shown in FIG. 14. At an f-ratio of 0.25, however, the lower band edges of the s- and p-polarized light spectra are virtually coincident as shown in FIG. 15, resulting in a film having a sharp color transition. Stated in different terms, it is most desirable to have the lower band edges of the s- and p-polarized light spectra within approximately 20 nm of each other, and more desirable to have them within approximately 10 nm of each other, to obtain the desired effect. For the modeled cases that are the subject of FIGS. 3 through 12, an f-ratio of 0.5 was used.

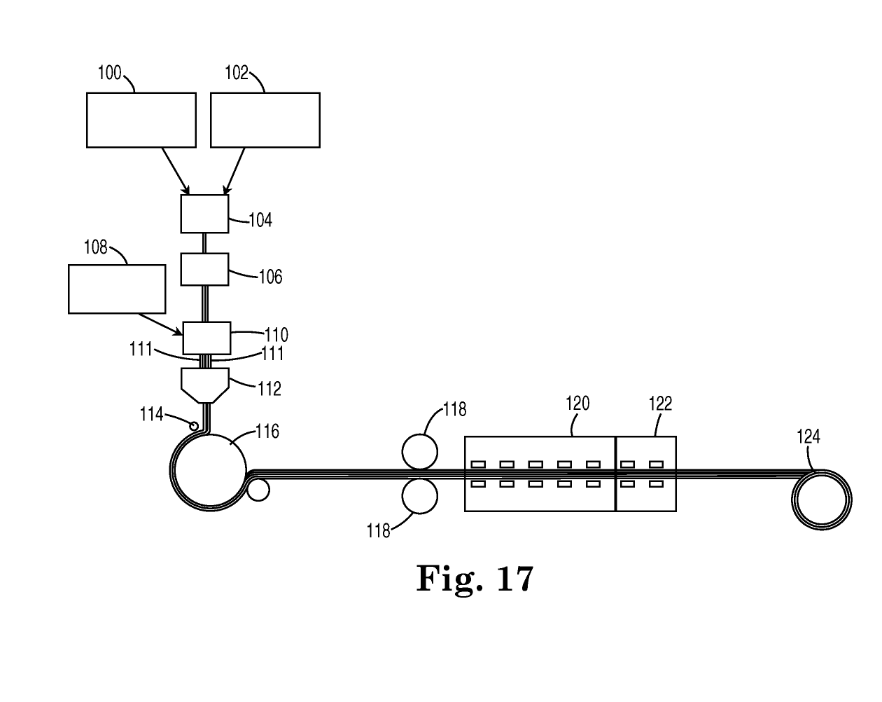

The optical theory underlying the modeled data described above will now be described in greater detail. A dielectric reflector is composed of layer groups that have two or more layers of alternating high and low index of refraction. Each group has a halfwave optical thickness that determines the wavelength of the reflection band. Typically, many sets of halfwaves are used to build a stack that has reflective power over a range of wavelengths. Most stack designs have sharp reflectivity decreases at higher and lower wavelengths, know as bandedges. The edge above the halfwave position is the high wavelength band edge, λ_{BEhi}, and the one below is the low wavelength band edge, λ_{BElo}. These are illustrated in FIG. 16. The center, edges, and width of a reflection band change with incidence angle.

The reflecting band can be exactly calculated by using a characteristic matrix method. The characteristic matrix relates the electric field at one interface to that at the next. It has terms for each interface and each layer thickness. By using effective indicies for interface and phase terms, both anisotropic and isotropic materials can be evaluated. The characteristic matrix for the halfwave is the product of the matrix for each layer of the halfwave. The characteristic matrix for each layer is given by Equation 6:

$$Equation 6 \text{:} \\ {M}_{1} = [ \begin{matrix} {M}_{11} & {M}_{12} \\ {M}_{21} & {M}_{22}\end{matrix} ] = [ \begin{matrix}\frac{exp [ {β}_{i} ]}{{t}_{i}} & \frac{{r}_{i} exp [ - {β}_{i} ]}{{t}_{i}} \\ \frac{{r}_{i} exp [ - β i ]}{{t}_{i}} & \frac{exp [ {β}_{i} ]}{{t}_{i}}\end{matrix} ]$$

where rᵢ and tᵢ are the Fresnel coefficients for the interface reflection of the i^{th} interface, and βᵢ is the phase thickness of the i^{th} layer.

The characteristic matrix of the entire stack is the product of the matrix for each layer. Other useful results, such as the total transmission and reflection of the stack, can be derived from the characteristic matrix. The Fresnel coefficients for the i^{th} interface are given by Equations 7(a) and 7(b):

$$Equations 7 ( a ) ; 7 ( b ) :$$

$${r}_{i} = \frac{{n}_{i} - {n}_{i - 1}}{{n}_{i} + {n}_{i - 1}} and {t}_{i} = \frac{2 {n}_{i}}{{n}_{i} + {n}_{i - 1}}$$

The effective indicies used for the Fresnel coefficients are given by Equations 8(a) and 8(b):

$$\begin{matrix}Equation 8 ( a ) \text{:} & \\ {n}_{is} = \frac{\sqrt{{n}_{ix}^{2} - {n}_{o}^{2} {sin}^{2} {θ}_{o}}}{cos {θ}_{o}} & ( for s polarized light and ) \\ Equation 8 ( b ) \text{:} & \\ {n}_{ip } = \frac{{n}_{ix} {n}_{iz} cos {θ}_{o}}{\sqrt{{n}_{iz}^{2} - {n}_{o}^{2} {sin}^{2} {θ}_{o}}} & ( for p polarized light )\end{matrix}$$

When these indicies are used, then the Fresnel coefficients are evaluated at normal incidence. The incident material has an index of nₒ and an angle of θₒ.

The total phase change of a halfwave pair, one or both may have anisotropic indicies. Analytical expressions for the effective refractive index were used. The phase change is different for s and p polarization. For each polarization, the phase change for a double transversal of layer i, β, is shown in Equations 9(a) and 9(b):

$$\begin{matrix}Equation 9 ( a ) \text{:} & \\ {β}_{is} = \frac{2 π di}{λ} \sqrt{{n}_{ix}^{2} - {n}_{o}^{2} {sin}^{2} {θ}_{o}} & ( for s polarized light ) \end{matrix}$$

$$Equation 9 ( b ) \text{:}$$

$${β}_{ip} = \frac{2 π di}{λ} \frac{{n}_{ix}}{{n}_{iz}} \sqrt{{n}_{iz}^{2} - {n}_{o}^{2} {sin}^{2} {θ}_{o}} \qquad ( for p polarized light )$$

where θₒ and nₒ are the angle and index of the incident medium.

Born & Wolf, in Principles of Optics, Pergamon Press 6th ed, 1980, p. 66, showed that the wavelength edge of the high reflectance region can be determined by evaluating the M₁₁ and M₂₂ elements of the characteristic matrix of the stack at different wavelengths. At wavelengths where Equation 10 is satisfied, the transmission exponentially decreases as more halfwaves are added to the stack.

$$Equation 10 :$$

$$\vert \frac{{M}_{11} + {M}_{22}}{2} \vert \geq 1$$

The wavelength where this expression equals 1 is the band edge. For a halfwave composed of two layers, multiplying the matrix results in the analytical expression given in Equation 11.

$$Equation 11 :$$

$$\vert \frac{{M}_{11} + {M}_{22}}{2} \vert = \vert cos ( {β}_{1} ) cos ( {β}_{2} ) - \frac{1}{2} ( \frac{{n}_{hi}}{{n}_{lo}} + \frac{{n}_{lo}}{{n}_{hi}} ) sin ( {β}_{1} ) sin ( {β}_{2} ) \vert \geq 1$$

The edge of a reflection band can be determined from the characteristic matrix for each halfwave. For a halfwave with more than two layers, the characteristic matrix for the stack can be derived by matrix multiplication of the component layers to generate the total matrix at any wavelength. A band edge is defined by wavelengths where Equation 11 is satisfied. This can be either the first order reflection band or higher order reflections. For each band, there are two solutions. There are additional solutions at shorter wavelengths where higher order reflections can be found.

A preferred method of making the multilayer film for use with the tear strip is illustrated schematically in FIG. 17. To make multilayer optical films, materials 100 and 102 selected to have suitably different optical properties are heated above their melting and/or glass transition temperatures and fed into a multilayer feedblock 104, with or without a layer multiplier 106. A layer multiplier splits the multilayer flow stream, and then redirects and “stacks” one stream atop the second to multiply the number of layers extruded. An asymmetric multiplier, when used with extrusion equipment that introduces layer thickness deviations throughout the stack, may broaden the distribution of layer thicknesses so as to enable the multilayer film to have layer pairs corresponding to a desired portion of the visible spectrum of light, and provide a desired layer thickness gradient. Skin layers may also be introduced by providing resin 108 for skin layers to a skin layer feedblock 110, as shown.

The multilayer feedblock feeds a film extrusion die 112. Feedblocks useful in the manufacture of the present invention are described in, for example, U.S. Pat. Nos. 3,773,882 (Schrenk) and 3,884,606 (Schrenk), the contents of which are incorporated by reference herein. As an example, the extrusion temperature may be approximately 295° C., and the feed rate approximately 10-150 kg/hour for each material. It is desirable in most cases to have skin layers 111 flowing on the upper and lower surfaces of the film as it goes through the feedblock and die. These layers serve to dissipate the large stress gradient found near the wall, leading to smoother extrusion of the optical layers. Typical extrusion rates for each skin layer would be 2-50 kg/hr (1-40% of the total throughput). The skin material may be the same as one of the optical layers, or a third polymer.

After exiting the film extrusion die, the melt is cooled on a casting wheel 116, which rotates past pinning wire 114. The pinning wire pins the extrudate to the casting wheel. To achieve a clear film over a broader range of angles, one need only make the film thicker by running the casting wheel more slowly. This moves the low band edge farther away from the upper end of the visible spectrum (700 nm). In this way, the color shift of the films of this invention may be adjusted for the desired color shift. The film is oriented by stretching at ratios determined with reference to the desired optical and mechanical properties. Longitudinal stretching may be done by pull rolls 118, and transverse stretching in tenter oven 120, for example, or the film may be simultaneously biaxially oriented. Stretch ratios of approximately 3-4 to 1 are preferred, although ratios as small as 2 to 1 and as large as 6 to 1 may also be appropriate to a given film. Stretch temperatures will depend on the type of birefringent polymer used, but 2° to 33° C. (5° to 60° F.) above its glass transition tempera would generally be an appropriate range. The film is typically heat set in the last two zones 122 of a tenter oven to impart the maximum crystallinity in the film and reduce its shrinkage. Employing a heat set temperature as high as possible without causing film breakage in the tenter reduces the shrinkage during a heated embossing step. A reduction in the width of the tenter rails by about 1-4% also serves to reduce film shrinkage. If the film is not heat set, heat shrink properties are maximized, which may be desirable in some security packaging applications. The film may be collected on windup roll 124.

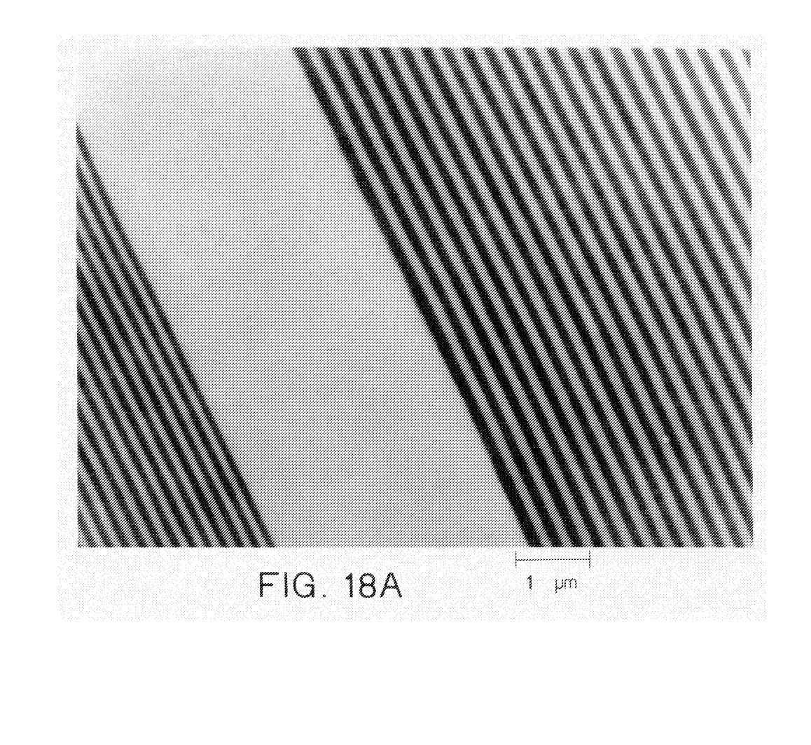

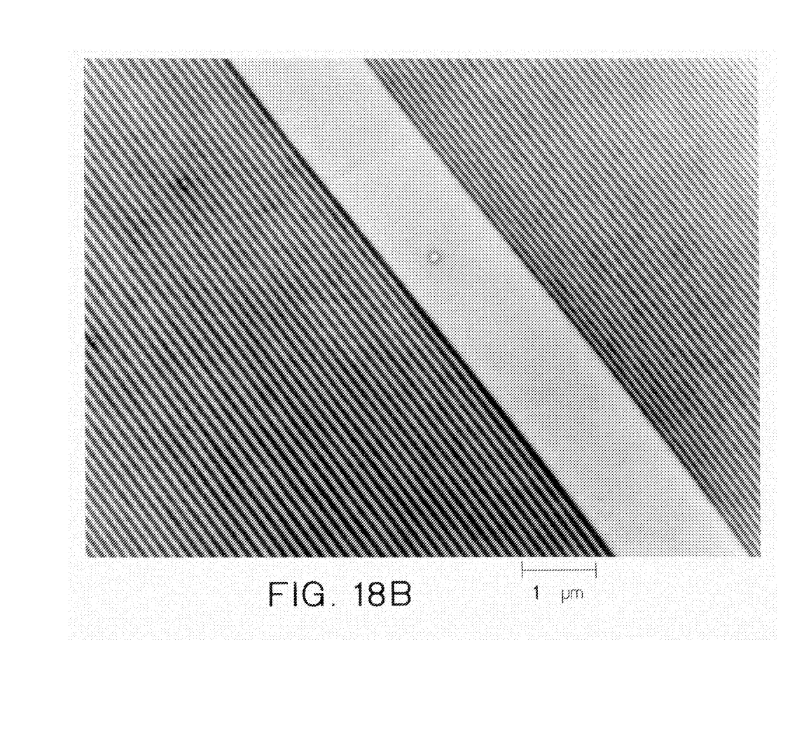

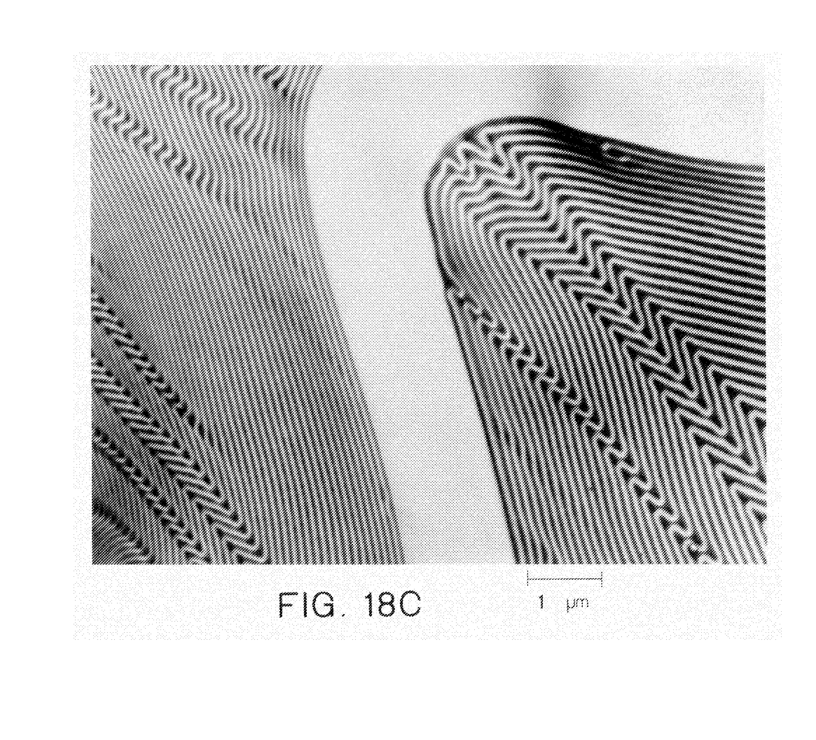

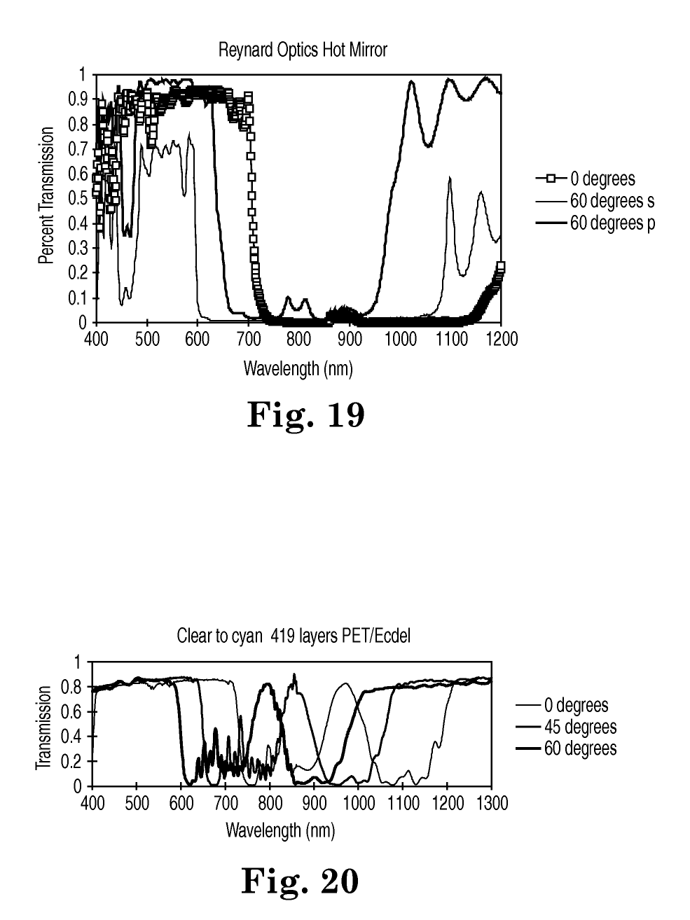

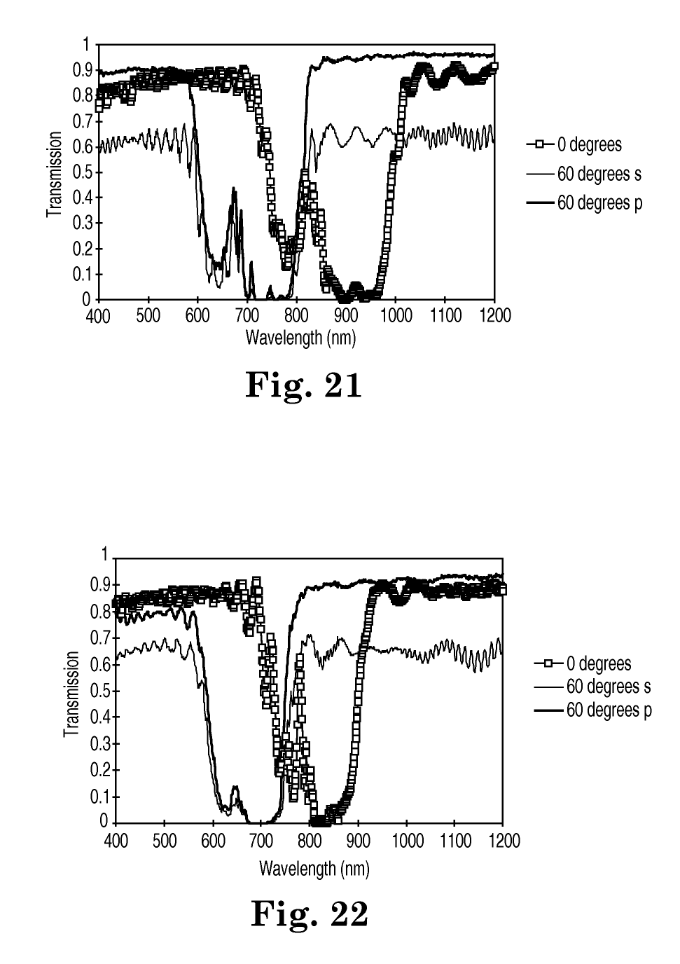

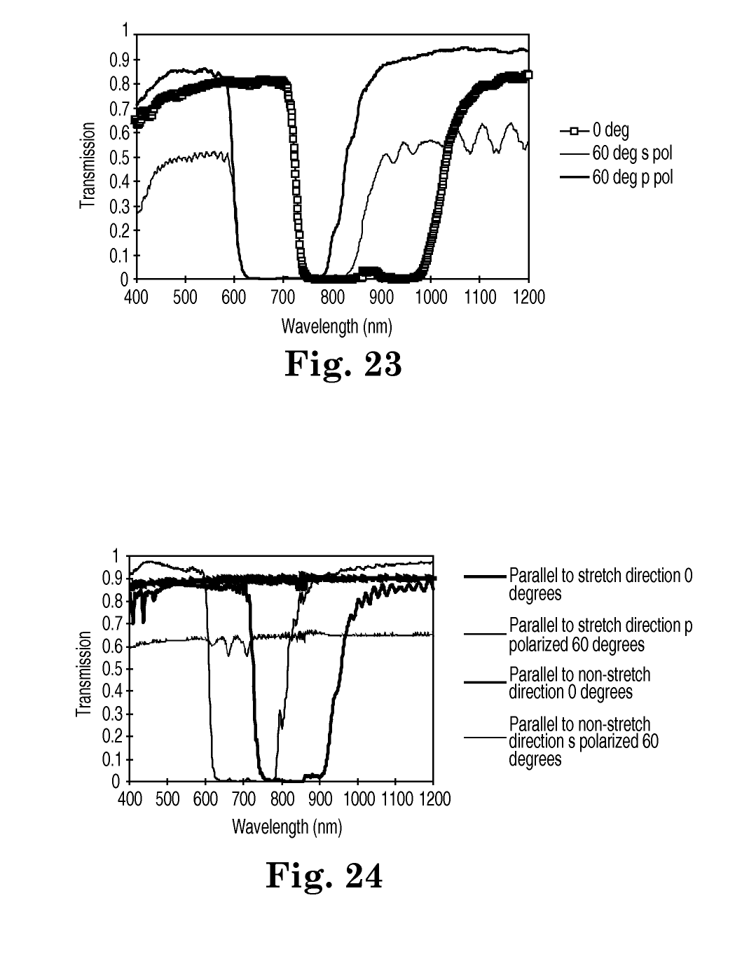

The multilayer film may also be embossed to provide a tear strip with a relief defining some customized information. The embossed image may be alphanumeric, for example, so that the name of the producer or issuer of the item of value will appear on the film. Official seals or corporate logos may also be embossed, and quite fine detail may be achieved. The film may be embossed by a male die alone, a male/female die combination, or a female die alone (in combination with, for example, an applied vacuum). It is preferred that the embossing step achieve a reduction in the layer thicknesses of the optical layers, and that the reduction be greater than 5%, preferably greater than approximately 10%. When this occurs, a noticeable shift in color of the embossed areas compared to the unembossed areas is achieved, which is believed to be due to layer thickness reduction and the deformative effects of embossing at the boundaries of the embossed areas. This effect is very different than what is observed in holograms, where multiple colors of the rainbow are seen as viewing angle is changed. FIGS. 18A, 18B, and 18C illustrate a multilayer film of the present invention before embossing, after embossing, and at an area between an embossed and an unembossed area, respectively. Note the overall compression in layer thickness between FIGS. 18A and 18B, and rippled layers in FIG. 18C. Embossing makes the clear to cyan film of the tear strip even more noticeable. The embossing step is preferably done above the glass transition temperature of both of the polymers in the multilayer film. In the case of a film that uses a third polymer for skin layers, these may either be removed prior to embossing, or also have a glass transition temperature below the desired embossing temperature.

In addition to the skin layer described above, which add physical strength to the film and reduce problems during processing, other layers and features of the film may include slip agents, low adhesion backsize materials, conductive coatings, antistatic, antireflective or antifogging coatings or films, barrier layers, flame retardants, UV stabilizers or protective layers, abrasion resistant materials, optical coatings, or substrates to improve the mechanical integrity or strength of the film. Noncontinuous layers may also be incorporated into the film to prevent tampering.

In accordance with the present invention, the multilayer film of the tear strip typically will have on a first major side an adhesive layer, typically a heat-activated or pressure sensitive adhesive layer. The adhesive layer should generally be clear and transparent and may comprise any of the heat-activated adhesives known, including olefin copolymers, pressure sensitive adhesives known, including acrylic or block copolymer pressure sensitive adhesives. If desired one or more primer layers may be provided between the adhesive layer and the multilayer film. Generally, the adhesive layer will be protected with a release liner, which will be removed when the tear strip is being associated with the wrapping material. Alternatively, a low adhesion backsize may be provided on the side of the multilayer film opposite to the side bearing the adhesive layer. In this case, the tear strip can be wound on itself and a release liner can be omitted.

In accordance with the present invention, the multilayer film may also comprise on the second major side a color layer. In one embodiment, the color layer is a continuous layer provided on the second major side. Such a color layer allows for the customization of the color shift of the tear strip when viewed under different angles.

Images may be provided on either major surface of the multilayer film, by any suitable technique. One example is the use of cyan ink (perhaps in addition to other colors) on the under side of a clear to cyan color-shifting film. Under those circumstances, the total printed image is visible at approximately a zero degree observation angle, but the cyan printing is hidden at angles greater than the shift angle. Another useful color for larger printed areas is black, because it absorbs any light that reaches it. In this case, only the specularly reflected red light is noticeable. In practice, black text with standard font sizes (8-18 point type), don't show this effect, because the adjacent white areas scatter sufficient cyan light at shallow angles to “wash out” the specular red. However, if larger black areas are used adjacent white areas, for example, the black areas appear red and the white areas appear cyan. There are numerous other possibilities of film color-shifts and inks behind the film to give customized appearances to the tear strip.

In another embodiment, the tear strip may comprise relief structures on one major side that for example define indicia representing for example a customized text, message, corporate name or logo. Relief structures may be obtained by embossing the multilayer film of the tear strip using an embossing as described above.

In yet a further embodiment, relief structures may be combined with a color layer provided on one major side of the multi-layer film and/or a printed image may be provided. The printed image may be in register with information defined by the relief structures or not.

The multilayer film can be converted into a tear strip by any suitable means. Typically, the multilayer film is converted into a series of tear strips by slitting the multilayer film into strips of a desired width. The slitting may be carried out by unwinding a roll of multilayer film and then slitting the unwound film followed by winding of the slit film to a series of rolls of tear strips. It will be typically advantageous to level wind the tear strip onto a spool such that an acceptable length of tear strip can be provided in one roll such that the production of wrapping material does not need to be interrupted frequently because of consumption of the roll of tear strip.

In a particular embodiment, the tear strip is provided with an image and/or with raised indicia. To produce tear strips with such marking, the multilayer film may be provided with a series of lanes of such markings across the width of the multilayer film. By longitudinal splitting of the multilayer film between adjacent markings in a series, a multiplicity of tear strips can be produced that are provided with the desired markings. Generally and in order to provide accuracy during the slitting operation, one or more registration markings should be provided allowing accurate positioning of the slitting knives by reading out the registration marking(s) with an appropriate sensor. In one particular embodiment where the multilayer film comprises a series of relief structures defining a series of indicia, a registration marking may be used that itself is provided as a relief structure. Thus, the registration mark may be produced in the same step and way as used for producing the relief structures representing the indicia. Generally, the relief structures defining indicia are provided by means of embossing the multilayer film and hence the registration mark may be provided by the embossing process as well.

As described above, the tear strip may further include an adhesive layer and/or a colored layer that may define an image as well as optional further layers such as primers. These layers are typically provided on the multilayer film before slitting so that after slitting a final tear strip ready to be associated with the wrapping material results.

In a particular embodiment in connection with this invention, the multilayer film used for producing the tear strip has a thickness of between 0.02 and 0.06 mm, for example about 0.040 mm. The lower edge of the reflection band in a preferred embodiment may be at about 740 nm and the upper edge may be at about 900 nm. In the region between these band edges greater than 99% of incident light is typically reflected. As a result of this transmission spectrum the film appears transparent if viewed from normal incidence. At 60°, the lack of transmitted red light makes the film appear in a deep cyan against a diffuse white background. In accordance with a particular embodiment, the film may be supplied in rolls of about 300 mm width and 2.000 m length. Depending on the width of the final tear tape and the converting equipment used, other roll widths and length might be used to achieve a minimum yield loss during subsequent converting steps. Generally the width of the tear strip is between 1 mm and 8 mm and the length may vary between 500 m and 30.000 m.

In a preferred embodiment, the multilayer film is embossed at regular intervals with indicia using a pair of heated steel rollers of which one is prepared with raised elements forming the indicia. The rollers may be heated to a temperature range of 100-120° C. for the embossing roller and 75-80° C. for the anvil roller. A line pressure in a range of 175 up to 700 N/cm is typically applied to form the embossed indicia. Typically, the indicia would be aligned along the unwind direction of the film to allow for slitting of the film between the indicia to make a tear strip. Alternatively, repeating indicia could be arranged at an angle to the unwind direction. In this case the slitting could be done in any position relative to the indicia to achieve a more economic converting process. The angle between embossed indicia and the slitting direction would provide at least one or multiple complete indicia in each strip.

The embossed areas of the film generally show a compression by about 10-20% depending on the base film used and the exact embossing geometry. The compressed areas of the film exhibit a shift of the reflection band to shorter wavelengths. For the example of a clear-to-cyan film, a gold color can be observed in the embossed areas changing to cyan prior to the unembossed areas when tilting.

The embossing design may include timing marks for down-web registration of a subsequent printing process. This allows for accurate positioning of printed indicia relative to the embossed indicia in the unwind direction of the film. An embossed timing mark for down-web registration may consist of an embossed rectangular area with 6.35 mm width and 9.5 mm length. Smaller or larger rectangles can be used, or other geometric shapes. In a particular embodiment of embossing a timing mark, a marking is provided as a solid embossed area. In another example, the rectangle can consist of multiple embossed single lines or dots or other shapes to improve scattering of light. The embossed area will typically exhibit a different reflection and transmission spectrum to the light emitted by a light diode and thus can be identified by position sensors that are commercially used in the printing industry.

In another embodiment, the embossing pattern can also include an embossed line for cross-web registration of a subsequent printing process. This allows for accurate positioning of printed indicia relative to the embossed indicia perpendicular to the unwind direction of the film. An embossed line for cross-web registration may have a width between 0.25 mm and 5 mm, or even wider widths. The line can again be embossed as a solid line or as a pattern of multiple single lines or dots of any shape. After embossing, the multilayer film material can be rewound into rolls of 300 mm by 2.000 meters or other formats suitable for subsequent converting steps.

In accordance with another embodiment, one surface of the multilayer film can be provided with a layer of ink, or layers of multiple inks. Typically, an ink layer of about 10 μm thickness can be applied by a flexographic printing process. Depending on the type of ink, a corona treatment of the film surface may be preferred to achieve a sufficient ink adhesion. Alternatively, the ink can also contain primer materials such as chlorinated polyolefins to improve ink adhesion to the film, or a priming coating may be applied to the entire film prior to the printing steps.

For example, the ink applied on one side of the film typically provides for good diffuse scattering in direct contact with a clear-to-cyan film. For example, after application of a white ink layer, the film appears to be white in printed areas with a gold embossing when observed at a normal observation angle. The film appears to be cyan in printed areas when viewed from a shallower angle with the embossed area changing to cyan prior to the unembossed regions.

In another example, after the application of a black ink layer, the clear to cyan film appears to be black in printed areas with a gold embossing when observed at a normal observation angles. The film appears to be red in printed areas when viewed from a shallower angle with the embossed area changing to green.

Application of a printed pattern in registration to the embossing pattern can create additional unique visual effects and thus can provide additional benefit for the use of the tear tape as an authentication device. For example, the ink can be applied in a pattern leaving unprinted sections registered to the embossed indicia. These sections in the film can appear clear when viewed from normal incidence and cyan from shallow angles. The unprinted sections typically allow for an observation of the wrapped product.

In another embodiment, a red ink may be applied to the unembossed film in combination with a black print applied to the embossed indicia. This print pattern may provide a nearly constant red color in the unembossed film when tilted from 0° to beyond 60° observation angle in combination with a color shift from gold to green in embossed regions.

To convert the embossed multilayer film into a self-adhesive tape, the film may be provided with a pressure sensitive adhesive (PSA) and a low adhesion backsize (LAB) coating. For providing the LAB, one side of the film might be coated with a 125 nm layer based on poly vinly N-alkyl carbamate. To be able to provide a tear tape with the adhesive layer on the side facing the observer, the LAB is preferably coated onto the printed side of the film. The side of the film opposite to printing and LAB coating may then be provided with a layer of a transparent PSA. Depending on the required thickness of the adhesive layer, it is preferably laminated with a transfer adhesive such as #9458 or #8142 transfer adhesive available from 3M Company, St. Paul, Minn., USA. In other embodiments, the adhesive can also be coated out of solution or applied as a hot melt from an extruder. The adhesive-coated web is then rolled up so that the PSA layer is in contact with the low adhesion backsize applied to the opposite surface of the film.

For converting the film into a self-adhesive tear tape, the adhesive-coated web can be slit along the length of the web to the width of the tear tape. To make the observation of the color shift in various light conditions, allowing for easy authentication of the tear tape, the film can be slit to a width of 4-2 mm and above, preferably 4 mm and above. Preferably, the web is cut in multiple strands of tear tape and each strand level-wound onto a cardboard core to achieve an economic converting process. The level-wound spools allows for a run length during the following packaging process significantly greater than for a pancake wound roll of the same outer diameter. In the example, a finished spool would contain 10.000 linear meters of tear tape on a 6″ cardboard core with a spool diameter of 300 mm and a spool width of 150 mm.

The adhesive coated strips can then be adhered to one surface of a transparent biaxially-oriented polypropylene (BOPP) film having a thickness of about 20 μm. The transparent BOPP film bearing the tear strip can then be used to individually wrap consumer goods, e.g. packages of cigarettes for retail sale, each package containing ca. 20 cigarettes. The tear strip is preferably located on the side of the film contacting the product itself. In this manner, when the tear strip is grasped and pulled, it cuts through the polymeric film wrapping so that the wrapping can be easily removed.

When a consumer purchases the package having a tear strip according to the invention, they can visually identify and confirm that the cigarettes are an authentic product of the manufacturer indicated on the product packaging by identifying the tear strip with the advertised color changes. The embossed indicia on the tear strip further contribute as secondary authenticity marks and color changes. Thus, the tear strip can provide both authentication of the product and visual enhancement of the packaging, and at the same time generally does not substantially reduce the visibility of the packaging underlying the transparent film.

1. Wrapping material for wrapping an article, said wrapping material comprising a tear strip associated therewith, wherein said tear strip comprises a multilayer film comprising alternating layers of at least a first and second polymer, said multilayer film having a first optical appearance at a first observation angle and a second optical appearance at a second observation angle different from said first observation angle, said second optical appearance being different from the first optical appearance.

2. Wrapping material according to claim 1 wherein said multilayer film appears substantially clear at said first observation angle and colored at said second observation angle and said multilayer film having a series of layer pairs having an optical thickness of 360 nm to 450 nm.

3. Wrapping material according to claim 1 wherein said tear strip further comprises a layer of adhesive on a first major side of said multilayer film.

4. Wrapping material according to claim 1 wherein said multilayer film comprises on one major side a relief structure defining indicia.

5. Wrapping material according to claim 4 wherein said tear strip further comprises on a second major side of said multilayer film opposite to said first major side, a colored layer.

6. Wrapping material according to claim 5 wherein said colored layer defines an image.

7. Wrapping material according to claim 6 wherein said image comprises indicia that are in register with said relief structure defining indicia.

8. Wrapping material according to claim 4 wherein said raised structures display a color different from the color displayed by the background between said relief structure at said observation angle.

9. Packaged article comprising a wrapping material as defined in claim 1.

10. Method of authenticating an article comprising wrapping an article with a wrapping material as defined in claim 1.
